(19) United States
(12) Patent Application Publication
(10) Pub. No.: US 2026/0110377 A1
(43) Pub. Date: Apr. 23, 2026

(54) PRESS FITTING DEVICE, COMPONENTS AND METHOD WITH CRIMP INDICATION

(71) Applicant: Quick Fitting Holding Company, LLC, East Providence, RI (US)

(72) Inventor: Jeremy T. Cogswell, East Providence, RI (US)

(21) Appl. No.: 19/364,527

(22) Filed: Oct. 21, 2025

Related U.S. Application Data
(60) Provisional application No. 63/862,973, filed on Aug. 13, 2025.
(60) Provisional application No. 63/710,257, filed on Oct. 22, 2024.

(51) Int. Cl. F16L 13/14; B21D 39/04

(52) U.S. Cl. CPC F16L 13/142; B21D 39/046; F16L 2201/10

(57) ABSTRACT

A press fitting device, components and method provide one or more indicators to provide a visual indication that the fitting has been properly pressed around a pipe and that the correct amount of pressure has been provided to create a permanent seal. In embodiments, an indicator ring is retained within one or more windows of a main body component of the fitting and the indicator ring is expandable upon compression to be visible through the window(s).

### CROSS REFERENCE TO RELATED APPLICATIONS

This application claims the priority benefit to U.S. provisional patent application no. 63/862,973 filed on August 13, 2025 and U.S. provisional patent application no. 63/710,257 filed on October 22, 2024, the disclosures of which are incorporated by reference herein in their entireties.

### TECHNICAL FIELD

The present disclosure relates to fluid flow systems, and more particularly to press fittings with visual indicators for use in fluid flow systems.

### BACKGROUND AND SUMMARY

Piping systems exist to facilitate the flow of fluids (e.g., liquid, steam, gas (such as air) or plasma). For example, homes, schools, medical facilities, commercial buildings and other occupied structures generally require integrated piping systems so that water and/or other fluids can be circulated for a variety of uses. Liquids and/or gases such as cold and hot water, breathable air, glycol, compressed air, inert gases, cleaning chemicals, wastewater, plant cooling water and paint and coatings are just some examples of the types of fluids and gases that can be deployed through piping systems. Tubing and piping types can include, for example, copper, stainless steel, CPVC (chlorinated polyvinyl chloride), iron, black iron, ductile iron, gray iron, HDPE (high density polyethylene) and PEX (cross-linked polyethylene). For purposes of the present disclosure, the term “pipe” or “piping” will be understood to encompass one or more pipes, tubes, piping elements and/or tubing elements.

Piping connections are necessary to join various pieces of pipe and must be versatile in order to adapt to changes of pipe direction required in particular piping system implementations. For example, fittings and valves may be employed at the ends of open pieces of pipe that enable two pieces of pipe to fit together in a particular configuration. Among fitting types there are elbows, “tees”, couplings adapted for various purposes such as pipe size changes, ends, ball valves, stop valves, and partial angle connectors, for example.

In the past, pipe elements have been traditionally connected by welding and/or soldering using a torch. Soldering pipe fittings can be time-consuming, unsafe, and labor intensive. Soldering also requires employing numerous materials, such as copper pipes and fittings, emery cloths or pipe-cleaning brushes, flux, silver solder, a soldering torch and striker, a tubing cutter and safety glasses, for example. The process for soldering pipes can proceed by first preparing the pipe to be soldered, as the copper surface must be clean to form a good joint. The end of the pipe can be cleaned on the outside with emery cloth or a specially made wire brush. The inside of the fitting must be cleaned as well. Next, flux (a type of paste) can be applied to remove oxides and draw molten solder into the joint where the surfaces will be joined. The brush can be used to coat the inside of the fitting and the outside of the pipe with the flux. Next, the two pipes are pushed together firmly into place so that they “bottom out”—i.e., meet flush inside the fitting. The tip of the solder can be bent to the size of the pipe to avoid over-soldering. With the pipes and fitting in place, the torch is then ignited with the striker or by an auto-strike mechanism to initiate soldering. After heating for a few moments, if the copper surface is hot enough such that it melts when touched by the end of the solder, the solder can then be applied to the joint seam so that it runs around the joint and bonds the pipe and fitting together.

In addition to welding methods, pipe elements have been secured together through pressure. A press fitting, which is also known as a friction fit or an interference fit, is a fastening of parts that takes place through friction after the parts are pushed or compressed together, as opposed to being connected by threads, glue, solder or other methods. Press fittings of fluid flow parts such as plumbing parts can be created by force, through the use of a hand tool, for example. Hand tools, often called press tools, can take the form of a pair of movably engaged jaws similar to a pair of pliers, for example, where the jaws have a head portion of a certain size designed to fit around parts that are to be connected. For instance, a pipe can be inserted into a fitting made of a somewhat compressible material, whereupon pressure can be applied through the press tool to the outside of the fitting to compress the fitting around the pipe. It is critical that the press tool be appropriately applied around the entire circumference of the fitting to ensure a tight connection. Once connected, the parts can be used for various purposes. In the field of fluid flow, the connected parts can be used to direct the flow of fluids, such as gases, water and other liquids as described above.

Traditional press fittings are frequently improperly sealed or only partially sealed. If an installer has not properly pressed the fitting to provide a permanent seal, fluid can leak, causing great damage and cost. Imperfections or scarring in the tubing being inserted also presents an opportunity for the connection to leak following compression. In many installation environments, installers take work breaks or otherwise become distracted as to which of a number of press fittings have been properly compressed and which have been either improperly compressed or not at all. When this happens, there has been no simple and fast way (other than catastrophic failure or leakage) to determine which fittings have been properly pressed, which can result in lost time spent determining which fittings need to be pressed or have been damaged in the application environment.

In various cases, press style fittings require a machine to produce a watertight seal. Installers typically dry fit the whole piping network to ensure everything fits. The installer then moves around and crimps each fitting end, producing a seal. Typically, an inspector will also cover the installation area and ensure all fittings are in fact crimped. However, without a press indicator, ensuring that each crimp is proper and each connection is secure is difficult.

Press-fit technology for piping systems with visual indicators can be obtained, for example, through Quick Fitting Holding Company, LLC of East Providence, Rhode Island, USA.

Embodiments of the device of the present disclosure, in part, assist in providing one or more visual indicators to assist an individual in determining whether a piping element such as a fitting has been pressed, and whether the correct amount of force has been applied to create a positive and/or permanent seal. In embodiments of the present disclosure, a fitting is provided having a main body component, with a sealing ring or O-ring, grip ring or fastening ring and an optional O-ring gland securely maintained, at least in part, against a portion of the interior wall of the main body component. In various embodiments, an indicator ring and a guard ring are also employed, and the fitting exterior lip is formed with windows in the form of indentations or cutouts, for example, whereby as the fitting is compressed, the indicator ring extrudes from the initial surface and can be viewed through the window(s) and/or in areas between the windows, thereby indicating a proper seal. The indicator ring is malleable and expandable when properly compressed so as to extend around an inserted pipe. In this way, an installer, inspector or other individual can visually determine very quickly whether a press fitting has been compressed, and whether there is a proper and complete seal. In various embodiments, the sealing indicator ring is formed with one or more wings and the main body component is formed so as to facilitate the wing(s) extending into the window(s) to facilitate visually assessing when the fitting has been properly compressed. Embodiments of the present disclosure provide for an axially outer edge of the grip ring to be positioned against the axially inner edge of the indicator ring, and optionally for a ledge surface of the indicator ring to be positioned against an axial outer surface of the grip ring. Further embodiments are described herein where the grip ring is formed with a split defining a grip ring gap, and where the indicator ring formed with a notch extending radially outwardly of the indicator ring body, wherein the notch rests in the grip ring gap when the indicator ring is at rest.

Embodiments of the present disclosure can be employed in a variety of environments, including plumbing, HVAC, fire protection, irrigation and non-potable water environments. Embodiments of the present disclosure provide for an easy visual indication that a water-tight seal exists, with zero waste or leakage.

### BRIEF DESCRIPTION OF THE DRAWINGS

FIG. 1 is a side view of a fitting according to embodiments of the present disclosure.

FIG. 2 is a top plan view of a fitting according to embodiments of the present disclosure.

FIG. 3 is an exploded perspective view of an embodiment of the fitting according to the present disclosure.

FIG. 4 is a cross-sectional view of the fitting taken along line 4-4 of FIG. 2.

FIG. 5 is a close-up view of the dashed rectangular portion of FIG. 4.

FIG. 6 is a perspective view of an indicator ring according to embodiments of the present disclosure.

FIG. 7 is a cutaway view of a fitting according to embodiments of the present disclosure with a pipe installed and prior to crimping of the fitting.

FIG. 8 is a cutaway view of a fitting according to embodiments of the present disclosure with a pipe installed and after crimping of the fitting.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or a plurality of the described element. Thus, for example, reference to a sealing ring or o-ring may encompass one or more sealing rings or o-rings, reference to a wing may encompass one or more wings and so forth.

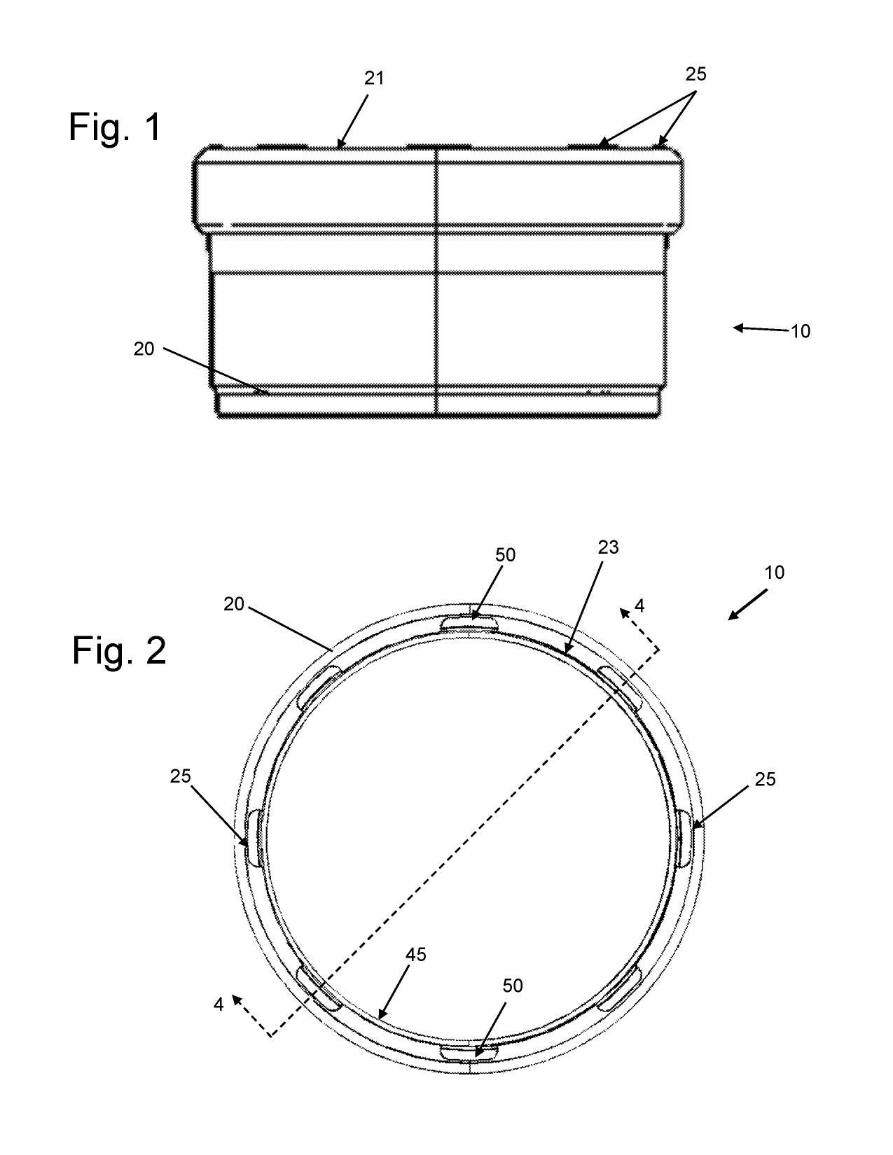

As shown in FIGS. 1 through 8, embodiments of the present disclosure provide a fitting 10 having a somewhat cylindrically shaped main body component 20 with an interior surface 11 and an exterior surface 13. The interior surface 11 defines a cavity 14 extending through the main body component 20 along a central axis A. The interior surface 11 is formed with an axially inner section 71 and an axially outer section 73, and the axially outer section 73 forms a packing cavity 74 for receiving various components according to embodiments of the present disclosure. In various embodiments, the main body component 20 is formed with an axially outer edge 21 with an exterior lip 23 formed with one or more cutouts or windows 25 therein. In various embodiments, the main body component 20 can be formed (e.g., forged, cast, extruded and/or pressed) in brass, aluminum, steel, malleable iron or copper, with full porting and full flow fitting, for example. In various embodiments, the windows 25 can be spaced around the circumference of the main body component 20 at different intervals that are generally radially equidistant from the central axis of the main body component, and such windows 25 permit a user to view internal components such as an indicator ring 50, for example, upon compression as described elsewhere herein. In various embodiments, the main body component 20 can be formed so as to have a constant radial thickness interrupted by one or more of the windows 25.

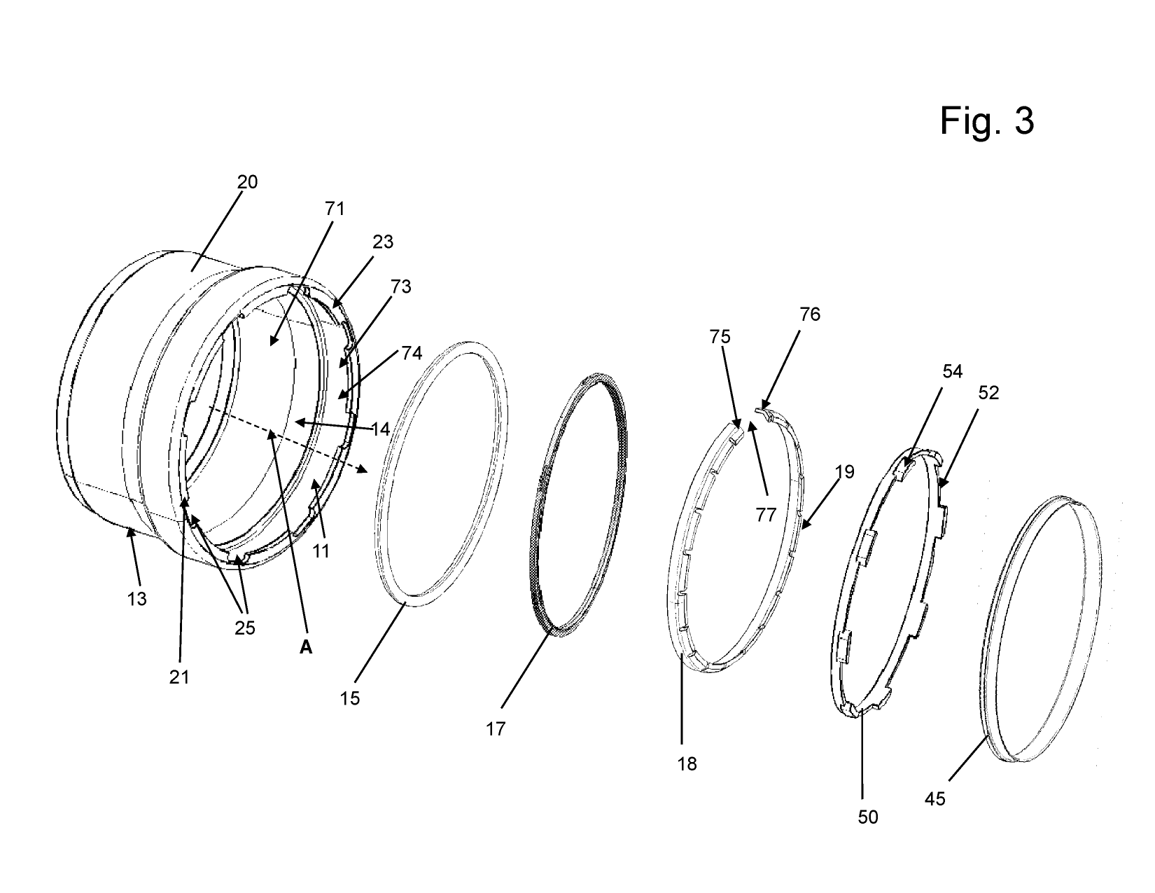

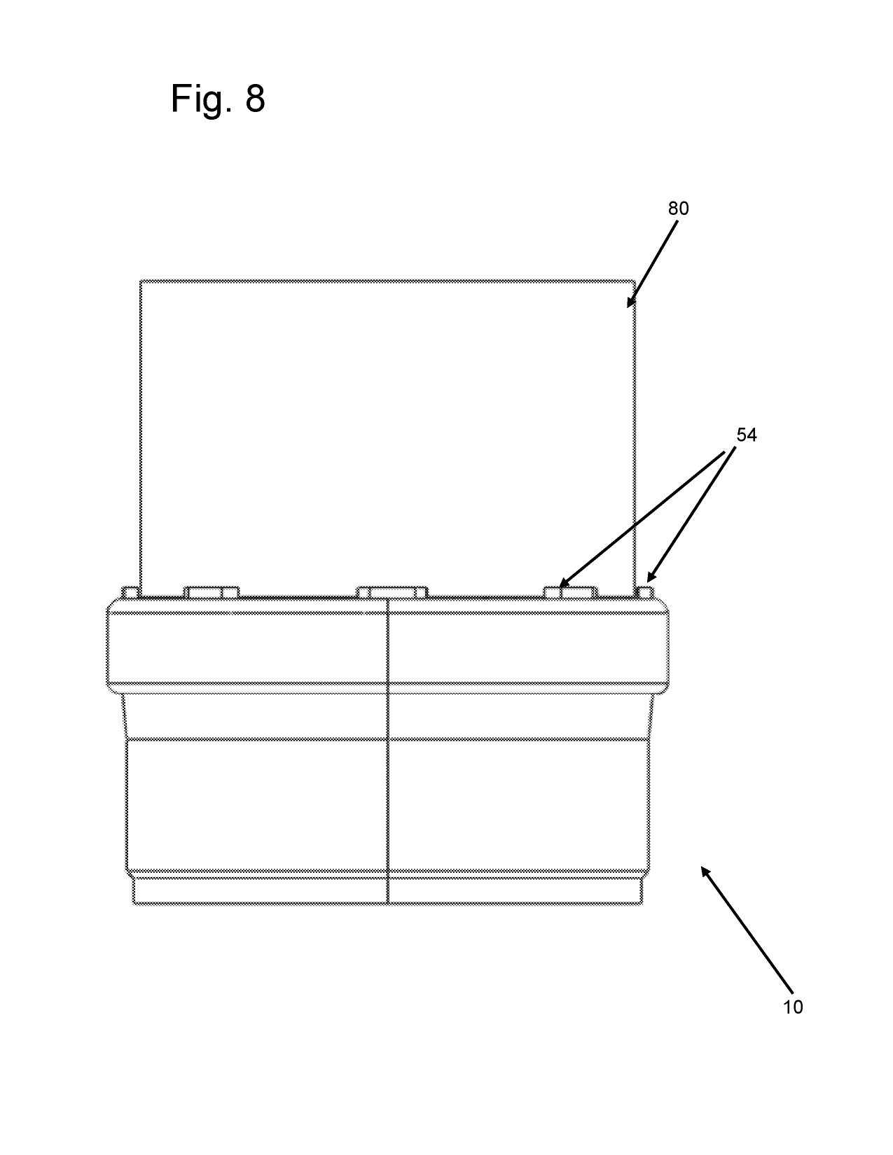

When a pipe of appropriate diameter is inserted into the main body component 20, internal components including an O-ring 15, an O-ring gland 17, a grip ring 18, a guard ring 45 and an indicator ring 50 previously installed in the packing cavity 74 permit the pipe to be received while facilitating a secure and water-tight seal around the pipe as described herein. As shown in FIGS. 3 through 5, the O-ring 15 is maintained within the packing cavity 74 at the axially innermost position. The O-ring gland 17 is maintained within the packing cavity 74 adjacent to and axially outwardly of the O-ring. The grip ring 18 is maintained within the packing cavity 74 adjacent to and axially outwardly of the O-ring gland 17. The guard ring 45 is maintained radially inwardly of, and in fitting communication with, the grip ring 18. The guard ring 45 operates to hold the O-ring 15 in place and help guide an inserted pipe (e.g., 80 in FIGS. 7 and 8) into the fitting 10. The indicator ring 50 is maintained at least partially between the guard ring 45 and the grip ring 18. As such, the indicator ring 50 is securely supported and operable to smoothly expand outwardly of the axially outer edge 21 of the main body component 20 when compressed. It will be appreciated that embodiments of the present disclosure operate without the O-ring gland 17, and other embodiments of the present disclosure operate without the O-ring gland and the guard ring 45.

The grip ring 18 can be formed with teeth 19 that engage an inserted pipe when the fitting is crimped as will be understood to those of skill in the art. In various embodiments, the grip ring 18 is formed as a split ring with ends 75, 77 that form a gap 76 therebetween. The forming of the main body component 20 according to embodiments as described herein provides a more open surface area for the indicator ring 50 to expand into as one or more pipes are inserted and clamping pressure is applied, as explained in more detail elsewhere herein.

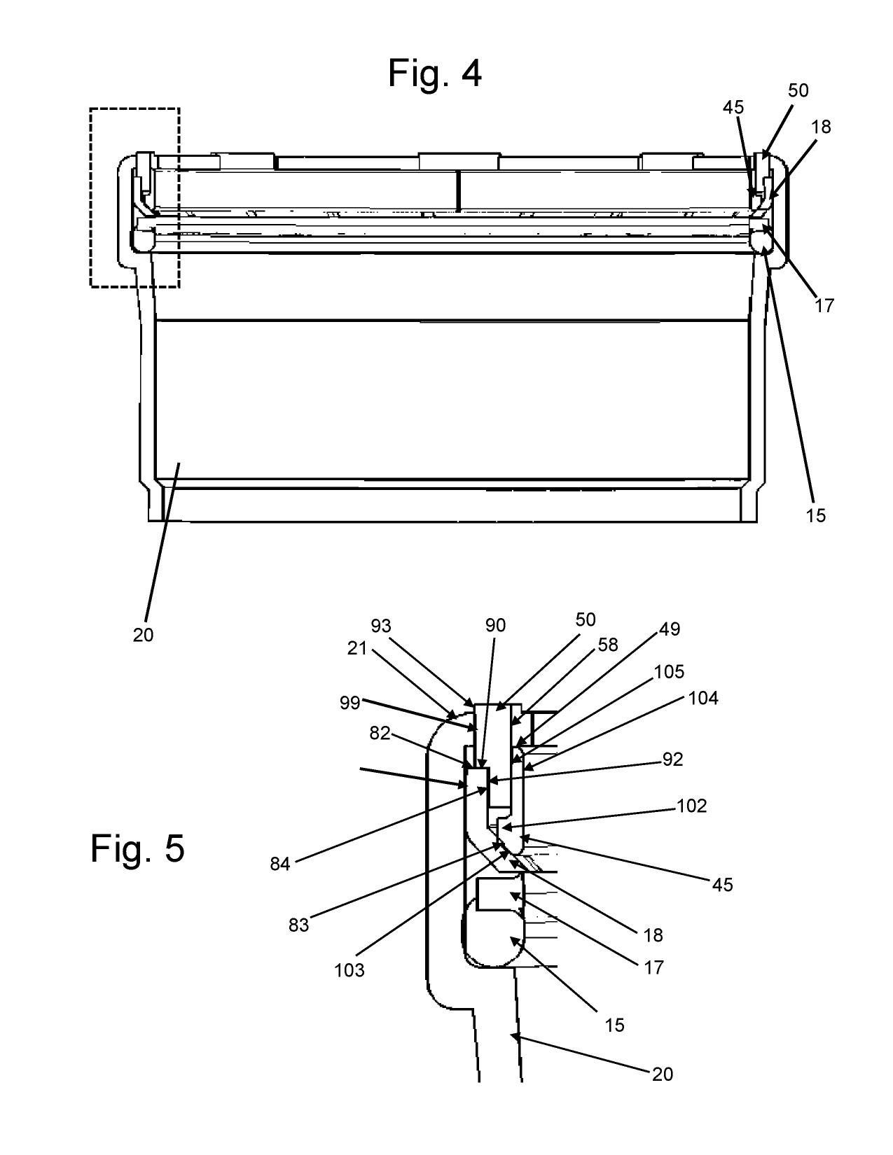

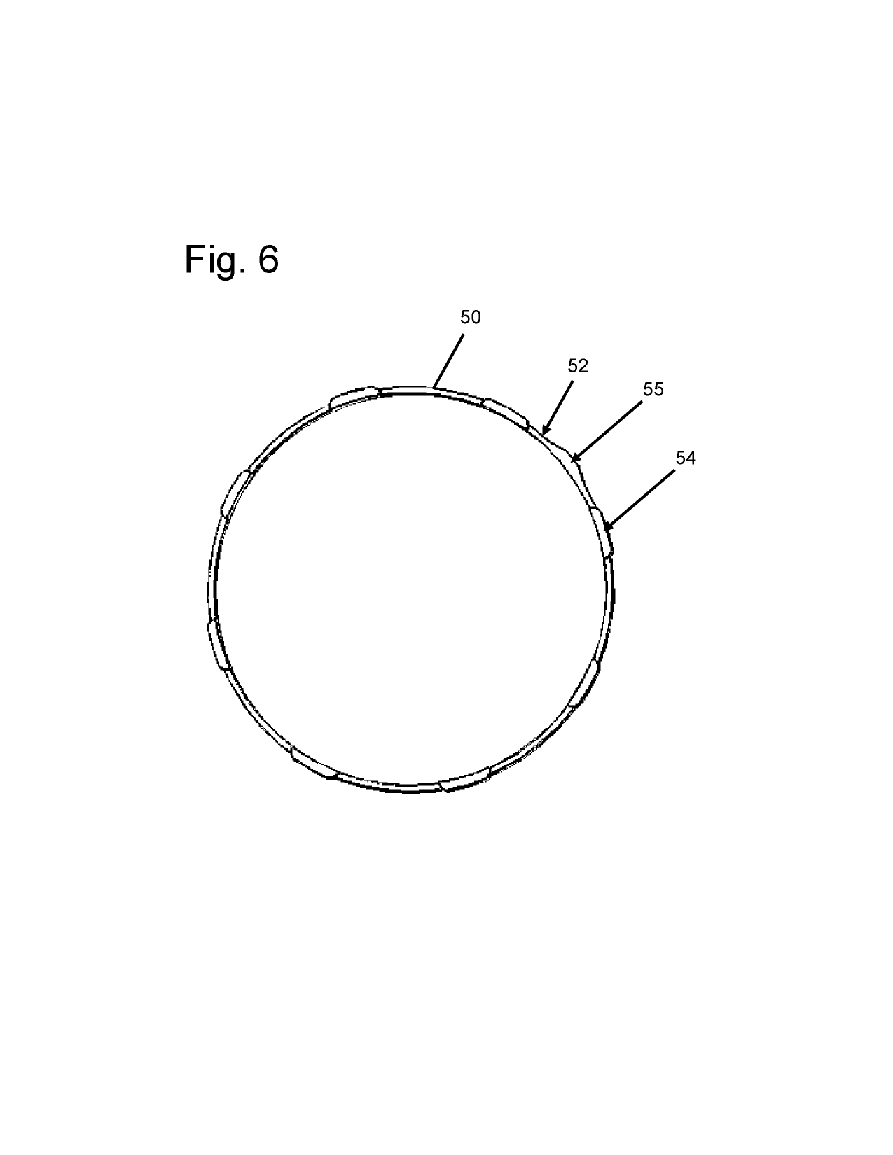

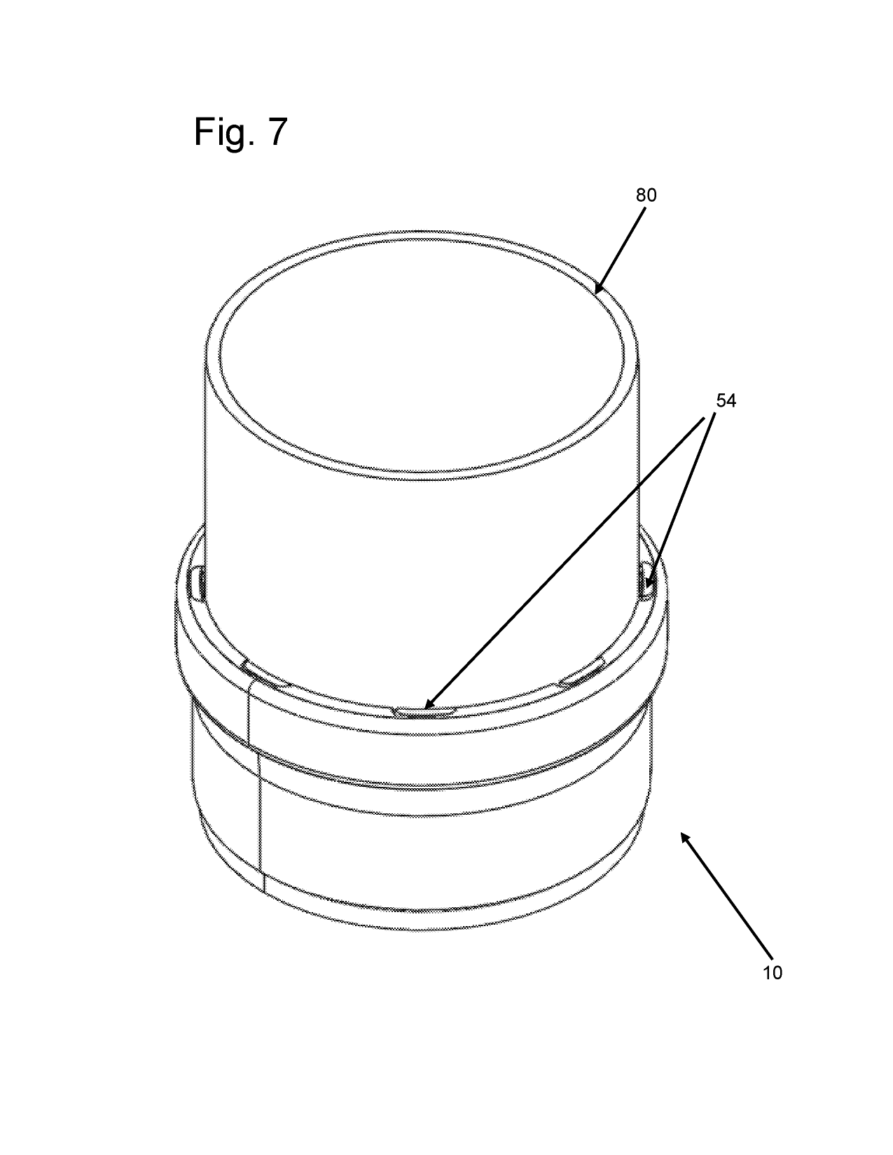

As referenced above and as shown in FIGS. 3 and 6, the indicator ring 50 can be substantially ring-shaped with a body 52 having a substantially circular cross-section monolithically formed with one or more nubs or wings 54 extending from the body 52. In various embodiments, each wing 54 extends axially outwardly of the indicator body 52 and lies within a respective window 25 of the main body component 20. The indicator ring 50 can be formed from a rubber, synthetic or similar non-metallic and compressible and/or expandable material. Optionally, ring 50 can be lubricated with a food grade lubricant, for example, when installed and during use. As shown in FIGS. 2 and 4, the indicator ring 50, when installed, has wing(s) 54 securely retained within the window(s) 25 of the main body component 20. It will be appreciated that the indicator ring 50 includes surfaces that provide structure to support interoperation, connection and engaged movement with other surfaces of other components of the present disclosure, as shown and described herein. In various embodiments, the indicator ring 50 is formed with a notch 55 extending radially outwardly thereof, wherein the notch 55 rests in the grip ring gap 76 when the indicator ring 50 is at rest. This facilitates operation as the lack of a notch 55 results in the remaining portion of the indicator ring 50 shifting into the gap 76 as the fitting 10 is crimped, which prevents or inhibits expansion of the indicator ring 50 axially outwardly so as to provide an indication of a proper crimp.

Also, the indicator ring 50 can lie axially aligned with or inwardly of the axially outer edge 21 of the main body component 20 and within at least one of the windows 25 of the lip 23 of the main body component when the indicator ring 50 is at rest, and lies axially outwardly of the axially outer edge 21 of the main body component 20 when the indicator ring 50 is compressed. Among other things, this helps an installer to visibly evaluate whether the device has been properly compressed during operation.

By introducing small cutouts or windows 25 along the fitting exterior lip 23 and incorporating an indicator ring 50 and guard ring 45 to the fitting 10, a crimp indicator is created. As the installer is in the process of crimping the fitting 10 around an inserted pipe (e.g., 80 in FIGS. 7 and 8), these windows 25 and overall fitting shape become compressed, producing an extrusion of the indicator ring 50 from the initial surface (e.g., at the axial outer edge 21 of the main body component 20), which can be considered a pre-crimp. As described elsewhere herein, the indicator ring 50 can be comprised of a rubber ring that has concentrated areas of larger volume (e.g., wings 54) to produce larger bumps of indication according to various embodiments of the present disclosure. In various embodiments, the wing(s) 54 of the indicator ring 50 can be viewed prior to crimping or after crimping. In various embodiments, the wing(s) 54 of the indicator ring 50 can be viewed prior to crimping and the body 52 of the indicator ring 50 extrudes outwardly and becomes visible in the spaces between the windows (e.g., 25 in FIGS. 2 and 6) after compression or crimping. In various embodiments, only the wing(s) 54 of the indicator ring 50 is/are visible after crimping, which can still provide a sufficient visual indication of a proper seal.

As shown in FIG. 5, embodiments of the grip ring 18 are formed with an axially outer edge 82, and embodiments of the indicator ring 50 are formed with an axially inward ledge 90, and wherein the axially outer edge 82 of the grip ring 18 is positioned against the axially inward ledge 90 of the indicator ring 50 when installed in the main body component 20. Embodiments of the grip ring further include a radially inner surface 83, 84, and embodiments of the indicator ring 50 include a radially outer surface 92, 93, wherein at least a portion the radially inner surface (e.g., 84) of the grip ring 18 is positioned against at least a portion of the radially outer surface (e.g., 92) of the indicator ring 50. In various embodiments, the radially outer surface 92, 93 of the indicator ring 50 includes a first segment 92 positioned against the radially inner surface portion 84 of the grip ring 18 and a second segment 93 positioned against a radially inner surface 99 of the axially outer edge 21 of the main body component 20. According to embodiments as described herein, the axially inward ledge 90 of the indicator ring 50 extends radially outwardly from the first segment 92 to the second segment 93. When assembled as disclosed with elements formed as disclosed, the indicator ring 50 is securely supported and operable to smoothly expand outwardly of the axially outer edge 21 of the main body component 20 when compressed.

According to various embodiments, the guard ring 45 holds the indicator ring 50 in place during installation. In various embodiments, the guard ring 45 has a lead in chamfer to help align the inserted pipe 80 into the fitting 10, reducing the chances of cutting the sealing O-ring 15 or any other internal component. As shown in the embodiment of FIG. 5, the guard ring 45 is formed with a rim portion 102 and a sleeve portion 104, wherein the rim portion 102 has a rim radially outer surface 103 and the sleeve portion 104 has a sleeve radially outer surface 105. The rim radially outer surface 103 can be positioned against at least a portion (e.g., 83) of the radially inner surface of the grip ring 18, and the sleeve radially outer surface 105 can be positioned against at least a portion of the radially inner surface 58 of the indicator ring 50. In various embodiments, the rim radially outer surface 103 extends a rim radial distance from the axis A, wherein the sleeve radially outer surface 105 extends a sleeve radial distance from the axis A, and wherein the rim radial distance 103 is greater than the sleeve radial distance 105. Each of the above-described aspects facilitates a tight engagement and retention of the indicator ring 50 with the grip ring 18 and guard ring 45, which facilitates expansion of the indicator ring 50 in accordance with the present disclosure.

In various embodiments, the guard ring 45 can also be provided with an upper lip that rests on the fitting edge to prevent rolling of the indicator ring 50. Embodiments of the guard ring 45 are ring-shaped with a split formed therein to facilitate manipulation for installation and removal. In various other embodiments, the guard ring 45 has an axially outer end 49 that lies axially inwardly of the axially outer edge 21 of the main body component 20.

In operation, prior to compression, the internal components including O-ring 15, O-ring gland 17, grip ring 18, guard ring 45 and indicator ring 50 are inserted into the main body component 20. In various embodiments, the O-ring gland 17 and/or guard ring 45 are not employed. A pipe 80 is then inserted into the cavity 14 with little or no resistance from the internal components, as the pipe outer surface can be of smaller diameter than at least the internal diameter of the uncompressed indicator ring 50 and grip ring 18. In various embodiments, the pipe outer surface can be of substantially the same diameter as the uncompressed indicator ring 50.

A press tool such as a tooling jaw or another device or machine can be applied around the outer surface of the main body component 20 when a pipe 80 has been inserted into the cavity thereof. As the press tool is properly applied, the indicator ring 50 is drawn into contact with the pipe outer surface and the indicator ring 50 is compressed axially outwardly so as to be visible externally of the fitting 10, as shown in FIG. 8. It will be appreciated that the indicator ring 50 can be of sufficient durometer and have sufficient expandable material in order to appropriately extrude into a visible area when a pipe is inserted and the fitting is compressed, while also filling in any voids, scarring or imperfections in the pipe being inserted as well as in the fitting interior surface. The indicator ring 50 can also be of sufficient durometer in order to roll up or pinch when a pipe is improperly inserted, such as when the pipe is inserted at too oblique an angle into the fitting 10.

The present disclosure describes numerous embodiments, and these embodiments are presented for illustrative purposes only. These embodiments are described in sufficient detail to enable those skilled in the art to practice the embodiments, and it will be appreciated that other embodiments may be employed and that structural and other changes may be made without departing from the scope or spirit of the presently disclosed embodiments. Accordingly, those skilled in the art will recognize that embodiments of the present disclosure may be practiced with various modifications and alterations. Although particular features of the presently disclosed embodiments can be described with reference to one or more particular embodiments or figures that form a part of the present disclosure, and in which are shown, by way of illustration, specific embodiments, it will be appreciated that such features are not limited to usage in the one or more particular embodiments or figures with reference to which they are described. The present disclosure is thus neither a literal description of all embodiments nor a listing of features of any embodiments that must be present in all embodiments.

1. A fitting, comprising:
a main body component comprising an interior surface, an exterior surface, an axially inner section, an axially outer section and an axially outer edge, wherein the interior surface defines a cavity extending through the main body component along an axis, wherein the axially outer section comprises a packing cavity, and wherein the axially outer edge comprises a radially inwardly extending lip formed with a plurality of windows along a circumference thereof;
an O-ring maintained within the packing cavity;
an O-ring gland maintained within the packing cavity, adjacent to and axially outwardly of the O-ring;
a grip ring maintained within the packing cavity, adjacent to and axially outwardly of the O-ring gland;
a guard ring maintained radially inwardly of, and in fitting communication with, the grip ring; and
an indicator ring maintained at least partially between the guard ring and the grip ring, wherein the indicator ring comprises an expandable material that lies axially aligned with or inwardly of the axially outer edge and within at least one of the windows of the lip of the main body component when the indicator ring is at rest, and lies axially outwardly of the axially outer edge of the main body component when the indicator ring is compressed.

2. The fitting of claim 1, wherein the grip ring comprises an axially outer edge, wherein the indicator ring comprises an axially inward ledge, and wherein the axially outer edge of the grip ring is positioned against the axially inward ledge of the indicator ring.

3. The fitting of claim 1, wherein the grip ring comprises a radially inner surface, wherein the indicator ring comprises a radially outer surface, and wherein at least a portion the radially inner surface of the grip ring is positioned against at least a portion of the radially outer surface of the indicator ring.

4. The fitting of claim 3, wherein the radially outer surface of the indicator ring comprises a first segment positioned against the portion of the radially inner surface of the grip ring and a second segment positioned against a radially inner surface of the axially outer edge of the main body component.

5. The fitting of claim 4, wherein the axial inward ledge extends radially outwardly from the first segment to the second segment.

6. The fitting of claim 3, wherein the guard ring comprises a rim portion and a sleeve portion, wherein the rim portion comprises a rim radially outer surface, wherein the sleeve portion comprises a sleeve radially outer surface, wherein the rim radially outer surface is positioned against at least a portion of the radially inner surface of the grip ring, and wherein the sleeve radially outer surface is positioned against at least a portion of a radially inner surface of the indicator ring.

7. The fitting of claim 6, wherein the rim radially outer surface extends a rim radial distance from the axis, wherein the sleeve radially outer surface extends a sleeve radial distance from the axis, and wherein the rim radial distance is greater than the sleeve radial distance.

8. The fitting of claim 1, wherein the indicator ring comprises an indicator body portion and a plurality of wings extending axially outwardly of the indicator body portion, wherein each of the plurality of wings lies within a respective window of the plurality of windows.

9. The fitting of claim 1, wherein the grip ring is formed with a split defining a grip ring gap, and wherein the indicator ring comprises an indicator body formed with a notch extending radially outwardly thereof, wherein the notch rests in the grip ring gap when the indicator ring is at rest.

10. The fitting of claim 1, wherein the grip ring comprises an axially outer edge and a radially inner surface, wherein the indicator ring comprises an axially inward ledge and a radially outer surface, wherein the axially outer edge of the grip ring is positioned against the axially inward ledge of the indicator ring, and wherein the radially inner surface of the grip ring is positioned against at least a portion of the radially outer surface of the indicator ring.

11. The fitting of claim 1, wherein the guard ring comprises an axially outer end, wherein the axially outer end of the guard ring lies axially inwardly of the axially outer edge of the main body component.

12. A fitting, comprising:
a main body component comprising an interior surface, an exterior surface, an axially inner section, an axially outer section and an axially outer edge, wherein the interior surface defines a cavity extending through the main body component along an axis, wherein the axially outer section comprises a packing cavity, and wherein the axially outer edge comprises a radially inwardly extending lip formed with a plurality of windows along a circumference thereof;
an o-ring maintained within the packing cavity;
a grip ring maintained within the packing cavity, axially outwardly of the O-ring;
an indicator ring maintained radially inwardly of, and in fitting communication with, the grip ring, wherein the indicator ring comprises an expandable material that lies axially aligned with or inwardly of the axially outer edge of the main body component when the indicator ring is at rest and lies axially outwardly of the axially outer edge of the main body component when the indicator ring is compressed.

13. The fitting of claim 12, wherein the grip ring is formed with a split defining a grip ring gap, and wherein the indicator ring comprises an indicator body formed with a notch extending radially outwardly thereof, wherein the notch rests in the grip ring gap when the indicator ring is at rest.

14. The fitting of claim 12, wherein the grip ring comprises an axially outer edge, wherein the indicator ring comprises an axially inward ledge, and wherein the axially outer edge of the grip ring is positioned against the axially inward ledge of the indicator ring.

15. The fitting of claim 12, wherein the grip ring comprises a radially inner surface, wherein the indicator ring comprises a radially outer surface, and wherein at least a portion the radially inner surface of the grip ring is positioned against at least a portion of the radially outer surface of the indicator ring.

16. The fitting of claim 15, wherein the radially outer surface of the indicator ring comprises a first segment positioned against the portion of the radially inner surface of the grip ring and a second segment positioned against a radially inner surface of the axially outer edge of the main body component.

17. The fitting of claim 16, wherein an axially inward ledge of the indicator ring extends radially outwardly from the first segment to the second segment.

18. The fitting of claim 12, wherein the indicator ring comprises an indicator body portion and a plurality of wings extending axially outwardly of the indicator body portion, wherein each of the plurality of wings lies within a respective window of the plurality of windows.

19. The fitting of claim 12, wherein the grip ring comprises an axially outer edge and a radially inner surface, wherein the indicator ring comprises an axially inner edge and a radially outer surface, wherein the axially outer edge of the grip ring is positioned against the axially inner edge of the indicator ring, and wherein the radially inner surface of the grip ring is positioned against at least a portion of the radially outer surface of the indicator ring.

20. The fitting of claim 12, further comprising a guard ring maintained radially inwardly of, and in fitting communication with, the grip ring.
